(19) United States
(12) Patent Application Publication
(10) Pub. No.: US 2025/0171321 A1
(43) Pub. Date: May 29, 2025

(54) PHOSPHORUS STABILIZED ZEOLITES

(71) Applicant: BASF CORPORATION, FLORHAM PARK, NJ (US)

(72) Inventors: David M. Stockwell, Westfield, NJ (US); Christopher John Gilbert, South Brunswick, NJ (US); Michelle Scamporino, Neptune City, NJ (US)

(73) Assignee: BASF CORPORATION, FLORHAM PARK, NJ (US)

(21) Appl. No.: 18/841,490

(22) PCT Filed: Feb. 24, 2023
(86) PCT No.: PCT/US2023/013864

§ 371 Date: Aug. 26, 2024

Related U.S. Application Data
(60) Provisional application No. 63/315,832, filed on Mar. 2, 2022.

(51) Int. Cl. C01B 39/54; B01J 20/18; B01J 20/28; B01J 20/30; B01J 29/00; B01J 29/08; B01J 29/85; B01J 35/61; B01J 37/08; B01J 37/28; B01J 39/02; B01J 39/14; C10G 11/05; C10G 11/18

(52) U.S. Cl. CPC C01B 39/54; B01J 20/186; B01J 20/28059; B01J 20/3078; B01J 20/3085; B01J 29/005; B01J 29/084; B01J 29/85; B01J 35/613; B01J 37/08; B01J 37/28; B01J 39/02; B01J 39/14; C10G 11/05; C10G 11/18; B01J 2229/16; B01J 2229/183; B01J 2229/24; B01J 2229/37; C01P 2002/86; C01P 2006/12

(57) ABSTRACT

Disclosed herein are phosphated zeolites and methods of formation and stabilization thereof. In at least one embodiment, a phosphated zeolite is formed by performing one or more acid treatments on a zeolite using a phosphorus source, and subsequently increasing the reaction pH under conditions sufficient to induce condensation of phosphorus onto the zeolite and re-insertion of the extracted framework aluminum onto the zeolite.

### CROSS-REFERENCE TO RELATED APPLICATION(S)

This application claims the benefit of priority of U.S. Provisional Patent Application No. 63/315,832, filed Mar. 2, 2022, the disclosure of which is hereby incorporated by reference herein in its entirety.

### FIELD OF THE DISCLOSURE

The present disclosure relates to phosphorus stabilized zeolites, methods of preparation thereof, and methods of use thereof.

### BACKGROUND

FCC is the main source of world's butylenes production. Almost half of the butylenes production is sourced from FCC units, and more than 40% of it is consumed to make high octane blending components via alkylation units. Due to increasing demand for high octane gasoline, more and more refiners find it profitable to increase butylenes in their units. However, conventional olefin maximization additives based on ZSM-5 alone are not sufficient to meet this target. ZSM-5 additives make mainly propylene; thus, they make more propylene over butylenes. When the units are wet-gas compressor limited the use of ZSM-5 will increase propylene more than butylenes, thus reaching the liquefied petroleum gas (LPG) limit or other constraints before reaching the required butylenes yields. In such a scenario the unit needs a catalyst (or additive) solution which contributes to increased butylenes/propylene (C4=/C3=) ratio compared to ZSM-5.

Beta zeolite delivers butylenes more selectively than ZSM-5. However, beta zeolite is less active than ZSM-5 and is more expensive than ZSM-5, making the use of beta zeolite cost prohibitive in most instances. It is believed that by using a beta zeolite with more active sites (i.e., more framework aluminum with available acid sites at low silica to alumina ratio), the activity of beta zeolite can be improved, the dose or loading of beta zeolite for attaining a certain amount of butylenes can be reduced, and the cost associated with using beta zeolite can be mitigated. However, it is believed that low silica to alumina ratio (SAR) zeolites, such as, without limitations, a template free low SAR beta zeolite, are less stable in steam or strong acid solutions. There is thus a need to develop stable, low SAR zeolites, and methods for preparation thereof.

While such zeolites could be utilized for FCC applications, they could also be useful in many other applications including, without limitations, other catalytic processes (besides FCC), as adsorbents, ion exchange materials, and so on.

### SUMMARY

The following presents a simplified summary of various aspects of the present disclosure in order to provide a basic understanding of such aspects. This summary is not an extensive overview of the disclosure. It is intended to neither identify key or critical elements of the disclosure, nor delineate any scope of the particular embodiments of the disclosure or any scope of the claims. Its sole purpose is to present some concepts of the disclosure in a simplified form as a prelude to the more detailed description that is presented later.

In one aspect, a phosphated low silica to alumina ratio (SAR) zeolite is characterized by one or more of: an ²⁷Al nuclear magnetic resonance (NMR) peak, when run under dry conditions, at about 38 ppm that represents at least 50% of the total spectral area; a butylenes component steamed ZSA corrected to 40% Si—Al basis loading of 90 m²/g or greater; a butylenes production activity of at least 1.4 times greater than the butylenes production activity of a proper control component made from a phosphorus-free high SAR templated zeolite having the same structure; or an activity/SZSA of at least 1.8 times greater than an activity/SZSA of a proper control component made from a phosphorus-free high SAR templated zeolite having the same structure.

In at least one embodiment, the P/Al molar ratio of the zeolite is greater than about 0.2, greater than about 0.3, greater than about 0.5, or greater than about 0.7.

In at least one embodiment the P/Al molar ratio of the zeolite is between about 0.2 and about 0.8.

In at least one embodiment the SAR of the zeolite is less than about 30.

In at least one embodiment the SAR of the zeolite is less than about 28, less than about 25, less than about 20, or less than about 15.

In at least one embodiment the zeolite is selected from zeolites with the structure BEA, MSE, -SVR, FAU, MOR, CON, SOF, MFI, IMF, FER, MWW, MTT, TON, EUO, MRE, NAT, CHA, TUN, YFI, or a combination thereof.

In at least one embodiment the micropores of the zeolite structure comprise at least one of 10-member rings and/or 12-member rings.

In at least one embodiment the zeolite has BEA structure.

In at least one embodiment the zeolite is template free BEA having been produced without use of an organic template.

In at least one embodiment, the zeolite further has an Al₂O₃ concentration of greater than about 8 wt %, greater than about 10 wt %, or greater than about 12 wt %, based on total weight of the zeolite.

In at least one embodiment, any of the aforementioned zeolites are formed by performing one or more acid treatments on a zeolite to at least partially extract framework aluminum from the zeolite, wherein at least one of the one or more acid treatments comprises a phosphorus source, and subsequently increasing the reaction pH under conditions sufficient to induce re-insertion of at least a portion of the extracted framework aluminum onto the zeolite and condensation of phosphorus onto the zeolite.

In at least one embodiment, the phosphorus source comprises phosphoric acid.

In another aspect, a catalyst component comprises the zeolite of any one of the preceding embodiments and a non-zeolitic matrix.

In at least one embodiment, the component maintains a ZSA of at least about 70%, at least about 80%, or at least about 90% after steaming.

In another aspect, an adsorbent comprises the zeolite of any one of the preceding embodiments and a substrate.

In another aspect, an ion exchange material comprises the zeolite of any one of the preceding embodiments.

In another aspect, a phosphated zeolite is formed by performing one or more acid treatments on a zeolite to at least partially extract framework aluminum from the zeolite, wherein at least one of the one or more acid treatments comprises a phosphorus source, and subsequently increasing the reaction pH under conditions sufficient to induce re-insertion of at least a portion of the extracted framework aluminum onto the zeolite and condensation of phosphorus onto the zeolite.

In at least one embodiment, the SAR of the zeolite is less than about 30.

In at least one embodiment, the SAR of the zeolite is at least about 30.

In another aspect, a process for forming phosphated zeolite comprises: performing one or more acid treatments on a zeolite, wherein at least one of the one or more acid treatments comprises a phosphorus source, wherein the one or more acid treatments cause at least partial extraction of framework aluminum from the zeolite; and forming the phosphated zeolite by subsequently increasing the reaction pH under conditions sufficient to induce re-insertion of at least a portion of the extracted framework aluminum onto the zeolite and condensation of phosphorus onto the zeolite.

In at least one embodiment, at least a portion of the extracted framework aluminum is re-inserted as Al-O-P.

In at least one embodiment, the one or more acid treatments reduce the reaction pH to about 2.35 or less.

In at least one embodiment, at least one of the one or more acid treatments is performed for at least 30 minutes or for a duration sufficient to cause the framework aluminum to be extracted from the zeolite.

In at least one embodiment, a first acid treatment is performed using a phosphorus-free acid, and wherein a second or subsequent acid treatment is performed using the phosphorus source.

In at least one embodiment, increasing the reaction pH comprises increasing the reaction pH to about 3 to about 6, or to about 5 or greater.

In at least one embodiment, the phosphorus source comprises phosphoric acid or one or more phosphates that result in the formation of phosphoric acid.

In at least one embodiment, the one or more acid treatments comprise treatment with one or more of H₂SO₄, HNO₃, or HCl prior to treatment with the phosphorus source.

In at least one embodiment, the one or more acid treatments comprise adding a phosphorus source and a second mineral acid simultaneously.

In at least one embodiment, the zeolite is selected from zeolites with the structure BEA, MSE, -SVR, FAU, MOR, CON, SOF, MFI, IMF, FER, MWW, MTT, TON, EUO, MRE, NAT, CHA, TUN, YFI, or a combination thereof.

In at least one embodiment, the zeolite has BEA structure.

In at least one embodiment, the zeolite is template free BEA having been produced without use of an organic template.

In at least one embodiment, the method further comprises subsequently calcining the zeolite. In at least one embodiment, calcining occurs at a temperature ranging from about 400° C. to about 650° C., from about 425° C. to about 625° C., from about 450° C. to about 625° C., or about 500° C. to about 600° C., from about 450° C. to about 600° C., or from about 450° C. to about 550° C.

In another aspect, a process for forming a catalyst component comprises combining the zeolite of any of the preceding embodiments or the phosphated zeolite prepared by the process of any of the preceding embodiments and a non-zeolitic matrix.

In another aspect, a process for forming an adsorbent, comprising combining the zeolite of any one of preceding embodiments or the phosphated zeolite prepared by the process of any one of the preceding embodiments and a substrate.

In another aspect, a fluid catalytic cracking (FCC) composition comprises the catalyst component of any of the preceding embodiments.

In another aspect, a fluid catalytic cracking (FCC) catalyst composition comprises: a first component comprising the catalyst component of any of the preceding embodiments; and at least one additional component that is compositionally different from the first component.

In at least one embodiment, the second component comprises a zeolite selected from zeolites with the structure BEA, MSE, -SVR, FAU, MOR, CON, SOF, MFI, IMF, FER, MWW, MTT, TON, EUO, MRE, NAT, CHA, TUN, YFI, or a combination thereof.

In at least one embodiment, the second component comprises zeolite Y.

In another aspect, a method of cracking a hydrocarbon feed comprises contacting the feed with the FCC catalyst composition of any one of the preceding embodiments.

In another aspect, a fluid catalytic cracking (FCC) catalyst component comprises: the zeolite of any one of the preceding embodiments or the zeolite prepared by the process of any of the preceding embodiments; a zeolite selected from zeolites with the structure BEA, MSE, -SVR, FAU, MOR, CON, SOF, MFI, IMF, FER, MWW, MTT, TON, EUO, MRE, NAT, CHA, TUN, YFI, or a combination thereof; and a non-zeolitic matrix.

In at least one embodiment, the combining of the zeolite and the non-zeolitic matrix occurs in a slurry held at a temperature effective to induce the condensation of additional phosphate onto an already phosphated zeolite.

In at least one embodiment, the temperature is at least 40° C., at least 50° C., at least 60° C., or about 70° C.

Exemplary zeolites that may be encompassed by the instant disclosure include, without limitations, zeolites with the structure BEA (e.g., beta zeolite), MSE, -SVR, FAU (e.g., zeolite Y), MOR, CON, SOF, MFI (e.g., ZSM-5), IMF, FER, MWW, MTT, TON, EUO, MRE, NAT, CHA, TUN, YFI, or a combination thereof. In certain embodiments, zeolites that may be encompassed by the instant disclosure include, without limitations, (1) large pore zeolites (e.g., those having pore openings greater than about 7 Angstroms) such as, for example, USY, REY, silicoaluminophosphates SAPO-5, SAPO-37, SAPO-40, MCM-9, metalloaluminophosphate MAPO-36, aluminophosphate VPI-5, or mesoporous crystalline material MCM-41; REUSY, zeolite X, zeolite Y, de-aluminated zeolite Y, silica-enriched de-aluminated zeolite Y, zeolite Beta, ZSM-3, ZSM-4, ZSM-18 and ZSM-20, (2) medium pore zeolites (e.g., those having pore openings of from about 4 Angstroms to about 7 Angstroms) such as, for example, ZSM-5, MCM-68, ZSM-11, ZSM-11 intermediates, ZSM-12, ZSM-22, ZSM-23, ZSM-35, ZSM-38, ZSM-48, ZSM-57 silicoaluminophosphate SAPO-31 and (3) small pore zeolites (e.g., those having pore openings of less than about 4 Angstroms) such as, for example, erionite and ZSM-34. In certain embodiments, zeolites that may be encompassed by the instant disclosure include, without limitations, zeolite A, zeolite B, zeolite F, zeolite H, zeolite K-G, zeolite L, zeolite M, zeolite Q, zeolite R, zeolite T, mordenite, erionite, offretite, ferrierite, chabazite, clinoptilolite, gmelinite, phillipsite and faujasite.

In at least one embodiment, the low SAR zeolites may have an Al₂O₃ concentration of greater than about 4 wt %, greater than about 8 wt %, greater than about 10 wt %, greater than about 12 wt %, greater than about 15 wt %, greater than about 20 wt %, or greater than about 25 wt %, based on total weight of the zeolite.

In at least one embodiment, the P/Al molar ratio of the low SAR zeolites may be greater than about 0.2, greater than about 0.3, greater than about 0.5, or greater than about 0.7.

In at least one embodiment, a catalyst component comprising a phosphated zeolite as described herein maintains at least about 75%, at least about 80%, at least about 85%, or at least about 90% of its crystallinity after steaming (as may be assessed by comparing the steamed zeolite surface area (SZSA) to the zeolite surface area prior to steaming (ZSA)).

Any of the zeolites described herein may be formulated with additional constituents, such as, a non-zeolitic matrix or a substrate, in order to form a catalyst component, and adsorbent, or an ion exchange material for use in a variety of catalytic processes, adsorption processes, and the like.

A variety of phosphate sources may be condensed onto the zeolite. In one embodiment, the phosphate source is phosphoric acid. In certain embodiments, performing condensation of a phosphate source occurs at a target temperature, such as, from about 25° C. to about 150° C., from about 40° C. to about 120° C., from about 45° C. to about 100° C., or from about 50° C. to about 80° C.

In at least one embodiment, the instant disclosure provides for a process of forming a catalyst component, a process for forming an adsorbent, and a process for forming an ion exchange material by combining any of the phosphated zeolites (e.g., phosphated low SAR zeolites) described herein with one or more suitable constituents, such as a non-zeolitic matrix or a substrate.

In at least one embodiment, the instant disclosure encompasses a FCC catalyst composition that includes a catalyst component including any of the phosphate stabilized zeolites described herein and a non-zeolitic matrix (a first component) and at least one additional component that is compositionally different from the first component and may include a zeolite selected from zeolites with the structure BEA (e.g., beta zeolite), MSE, -SVR, FAU (e.g., zeolite Y), MOR, CON, SOF, MFI (e.g., ZSM-5), IMF, FER, MWW, MTT, TON, EUO, MRE, NAT, CHA, TUN, YFI, or a combination thereof. In certain embodiments, the second component may include zeolites such as, without limitations, (1) large pore zeolites (e.g., those having pore openings greater than about 7 Angstroms) such as, for example, USY, REY, silicoaluminophosphates SAPO-5, SAPO-37, SAPO-40, MCM-9, metalloaluminophosphate MAPO-36, aluminophosphate VPI-5, or mesoporous crystalline material MCM-41; REUSY, zeolite X, zeolite Y, de-aluminated zeolite Y, silica-enriched de-aluminated zeolite Y, zeolite Beta, ZSM-3, ZSM-4, ZSM-18 and ZSM-20, (2) medium pore zeolites (e.g., those having pore openings of from about 4 Angstroms to about 7 Angstroms) such as, for example, ZSM-5, MCM-68, ZSM-11, ZSM-11 intermediates, ZSM-12, ZSM-22, ZSM-23, ZSM-35, ZSM-38, ZSM-48, ZSM-57 silicoaluminophosphate SAPO-31 and (3) small pore zeolites (e.g., those having pore openings of less than about 4 Angstroms) such as, for example, erionite and ZSM-34. In certain embodiments, the second component may include zeolites such as, without limitations, zeolite A, zeolite B, zeolite F, zeolite H, zeolite K-G, zeolite L, zeolite M, zeolite Q, zeolite R, zeolite T, mordenite, erionite, offretite, ferrierite, chabazite, clinoptilolite, gmelinite, phillipsite and faujasite.

In at least one embodiment, the instant disclosure encompasses a FCC catalyst component that includes any of the phosphate stabilized zeolites described herein in combination with any of the zeolites listed hereinabove and a non-zeolitic matrix.

In at least one embodiment, the instant disclosure encompasses a method of cracking a hydrocarbon feed by contacting a feed with any of the FCC catalyst compositions described herein.

In one aspect, a zeolite comprises phosphated low silica to alumina ratio (SAR) zeolite. In at least one embodiment, the low SAR zeolite is a zeolite with a SAR lower than about 30. In at least one embodiment, the SAR is less than about 28, less than about 25, less than about 20, or less than about 15.

In at least one embodiment, the P/Al molar ratio of the phosphated zeolite is greater than about 0.2, greater than about 0.3, greater than about 0.5, or greater than about 0.7. In at least one embodiment, the P/Al molar ratio of the zeolite is between about 0.2 and about 0.8.

In at least one embodiment, the zeolite is selected from zeolites with the structure BEA, MSE, -SVR, FAU, MOR, CON, SOF, MFI, IMF, FER, MWW, MTT, TON, EUO, MRE, NAT, CHA, TUN, YFI, or a combination thereof.

### BRIEF DESCRIPTION OF THE DRAWINGS

The above and other features of the present disclosure, their nature, and various advantages will become more apparent upon consideration of the following detailed description, taken in conjunction with the accompanying drawings, in which:

FIG. 1A shows ²⁷Al NMR spectra run under dry conditions for samples subjected to calcination in air;

FIG. 1B shows ²⁷Al NMR spectra run under hydrated conditions for samples subjected to calcination in air;

FIG. 2A shows ²⁷Al NMR spectra run under dry conditions for phosphated TF beta zeolite powders after fluid bed calcination;

FIG. 2B shows ²⁷Al NMR spectra run under hydrated conditions for phosphated TF beta zeolite powders after fluid bed calcination;

FIG. 3 shows spectra from ²⁷Al NMR run under dry conditions for samples subjected to powder steaming;

FIG. 4 shows the raw butylenes and propylene yields versus amount of butylenes component;

FIG. 5 shows butylenes yields that reveal no degradation in selectivity of examples prepared in accordance with certain embodiments; and

FIG. 6 illustrates an exemplary chemical process in accordance with certain embodiments of the disclosure.

### DEFINITIONS

The term “low SAR zeolite,” as used herein, refers to a zeolite with a SAR lower than about 30, lower than about 28, lower than about 25, lower than about 20, or lower than about 15. In certain embodiments the methods and compositions described herein encompass zeolites having a SAR of 30 or greater, e.g., a SAR ranging from about 5 to about 150, about 10 to about 100, or about 15 to about 50, about 30 to about 150, about 30 to about 100, or about 30 to about 50, or any sub-range or single SAR value therein. The term “high SAR zeolite,” as used herein, encompasses zeolites having a SAR of 30 or greater.

The term “substantially intact,” as used herein, refers to at least two out four bonds in a tetrahedral framework aluminum remaining intact as Al-O—Si bonds, such that the aluminum remains chemically bound to the tetrahedral framework rather than completely de-aluminated or chemically detached from the tetrahedral framework.

The term “completely de-aluminated” or “bulk de-alumination” are used interchangeably throughout the description. These terms refer to aluminum that is fully chemically detached from the zeolite framework such that it is no longer chemically bound and can be separated from the zeolite through physical means (e.g., filtration). The term “completely de-aluminated” or “bulk de-alumination” should be distinguished from partially de-aluminated (or partially hydrolyzed) aluminum, also referred to herein as “partially dislodged tetrahedral framework aluminum” (AlTa), which remains chemically bound to the zeolite framework, is available to bind phosphorus, cannot be separated from the zeolite framework by physical means (e.g., filtration), and can be detected via, e.g., nuclear magnetic resonance (NMR) spectroscopy or Fourier-transform infrared (FTIR) spectroscopy. The term “completely de-aluminated” or “bulk de-alumination” should also be distinguished from octahedral non-framework aluminum, which may be formed when bulk de-alumination is minimal, yet is believed to not be substantially intact (as defined hereinabove) because it is believed to not be chemically bound to the zeolite framework through bonds with framework —O—Si_{T}—. Instead it may be in the form of a cation associated with framework Al, or occur as neutral clusters in the micropores. Octahedral aluminum can also be detected via NMR.

The term “partially dislodged tetrahedral framework aluminum” (AlTa), as used herein, refers to at least one out four Al—O—Si bonds (but no more than three Al—O—Si bonds) in a tetrahedral framework aluminum being chemically detached while the remaining Al—O—Si bonds remaining intact, such that the aluminum remains partially chemically bound to the framework rather than completely chemically detached from the framework.

The term “chemically bound,” as used herein, means that the aluminum cannot be separated through physical means (e.g., filtration).

As used herein, the term “catalyst” or “catalyst composition” or “catalyst material” “catalyst component” refers to a material that promotes a reaction.

As used herein, the term “fluid catalytic cracking” or “FCC” refers to a conversion process in petroleum refineries wherein high-boiling, high-molecular weight hydrocarbon fractions of petroleum crude oils are converted to more valuable gasoline, olefinic gases, and other products.

As used herein, the term “feed” or “feedstock” refers to that portion of crude oil that has a high boiling point and a high molecular weight. In FCC processes, a hydrocarbon feedstock is injected into the riser section of an FCC unit, where the feedstock is cracked into lighter, more valuable products upon contacting hot catalyst circulated to the riser-reactor from a catalyst regenerator.

As used herein, the terms “non-zeolitic component” or “matrix” or a “non-zeolitic matrix” refer to the components of an FCC catalyst that are not zeolites or molecular sieves. As used herein, the non-zeolitic component can comprise binder and filler.

As used herein, the term “zeolite” refers to a crystalline aluminosilicate with a framework based on an extensive three-dimensional network of silicon, aluminum and oxygen ions and have a substantially uniform array of pores.

As used herein, the term “composition” or “catalyst composition” refers to a blend or a mixture of two or more separate and distinct components, such as a first component mixed or blended with a second component. In certain embodiments, the components in the composition are chemically combined and cannot be separated through physical means (e.g., filtration). In other embodiments, the components in the composition are not chemically combined and may be separated through physical means.

As used herein, the singular forms “a,” “an,” and “the” include plural references unless the context clearly indicates otherwise. Thus, for example, reference to “a microsphere” includes a single microsphere as well as a mixture of two or more similar or different microspheres, and the like.

As used herein, the term “about” in connection with a measured quantity, refers to the normal variations in that measured quantity, as expected by one of ordinary skill in the art in making the measurement and exercising a level of care commensurate with the objective of measurement and the precision of the measuring equipment. In certain embodiments, the term “about” includes the recited number ±10%, such that “about 10” would include from 9 to 11.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to illuminate certain materials and methods and does not pose a limitation on scope. No language in the specification should be construed as indicating any non-claimed element as essential to the practice of the disclosed materials and methods.

### DETAILED DESCRIPTION

Various embodiments of the present disclosure relate to phosphated zeolites, such as low silica-to-alumina ratio (SAR) zeolites. In at least one embodiment, a phosphated zeolite (e.g., a template-free beta zeolite) is modified with phosphorus such that a significant portion of the framework-bound aluminum is chemically bound via oxygen to phosphorus. The phosphorus bound to the framework, in certain embodiments, or substantially all of the bound phosphorus, are not members of polyphosphate chains, and the framework is restored to have nearly all of its original aluminum substantially intact with a P/Al molar ratio between about 0.2 and 0.8. The phosphorus-free ZSA of the material after calcination may be above 400 m²/g, preferably about 440 m²/g, compared to the calcined ZSA of an unmodified template-free beta zeolite of about 440 m²/g.

Certain embodiments described herein relate to a process for producing phosphated zeolites, which utilize a strong acid before, after, or in combination with a phosphorus source (e.g., H₃PO₄), such that the reaction pH of the zeolite slurry is driven significantly below 2.35 in order to induce the bulk extraction and dissolution of a substantial portion of the original framework aluminum. Under such conditions, the prevalence of uncharged H₃PO₄(aq) is increased, and the P/Al dose can be any value independent of the extent of aluminum extraction. The acidic aluminum extraction is then followed by neutralization with a base that results in the re-insertion of the extracted aluminum back into the zeolite framework, where the restored framework aluminum is bound via oxygen to phosphorus after calcination under appropriate conditions. The neutralization also features re-condensation of hydrolyzed Al—O—Si bonds such that the acid damage to the zeolite is substantially healed. In certain embodiments, the product is filtered and washed to remove solvated and weakly bound phosphates, sulfates, nitrates etc., and the concentration of H₃PO₄ used during condensation or present during drying is low enough to preclude the formation of polyphosphoric acid in solution or polyphosphates upon drying and calcination.

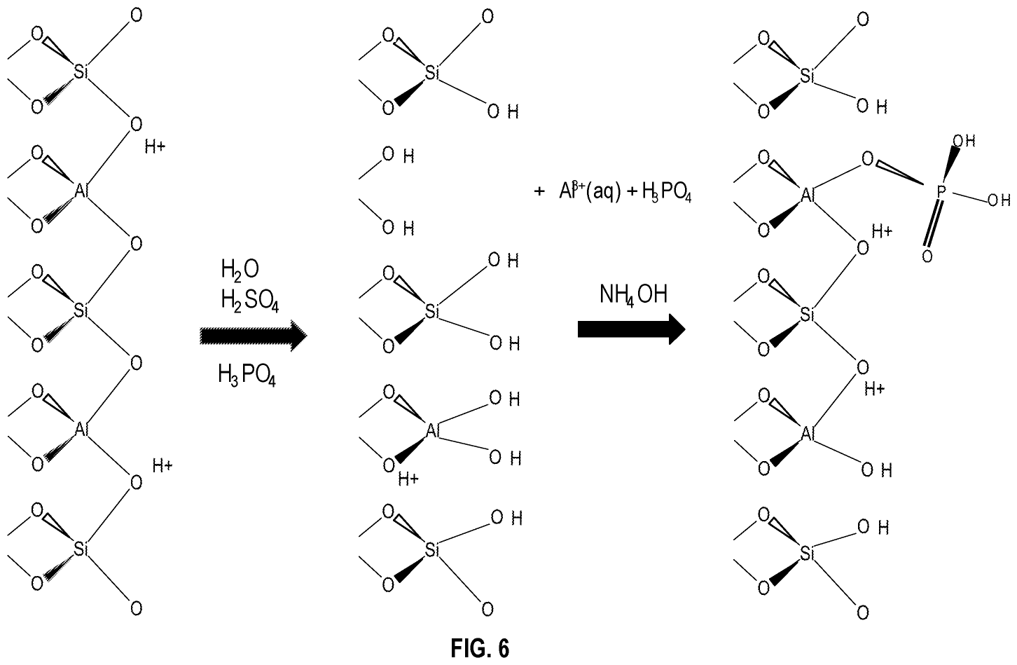

As used herein, the terms “heal,” “healed,” or “healing” relate to a state of a partially- or fully-dealuminated zeolite after being subjected to conditions sufficient to induce re-insertion of extracted, solution-phase aluminum into the zeolitic framework and/or condensing adjacent Al-OH and Si—OH pairs, whether or not phosphorus is present. An exemplary chemical process resulting in at least partial healing of the zeolitic framework and phosphorus condensation is illustrated in FIG. 6. Phosphorus condensation may also occur on aluminum that was not extracted during any prior processing.

A zeolite with a low SAR, such as a template free beta zeolite, has a higher aluminum content which is believed to potentially correspond to a higher specific activity (since the active sites of a zeolite are believed to be on the framework aluminum). The term “specific activity,” as used herein refers to the activity of the zeolite per zeolite surface area. It has been observed that the zeolite structure (e.g., structure of a template free beta zeolite) destabilizes upon exposure to steam. This is believed to occur due to rapid de-alumination (i.e., when the aluminum comes out of the zeolite framework) upon exposure of the zeolite to steam. Attempts have been made to stabilize various zeolites through the inclusion of rare earth oxides and/or phosphorus.

Existing methods of incorporating phosphorus into a zeolite (e.g., incipient wetness, impregnation, slurrying phosphoric acid with zeolite, phosphoric acid spray drying, and so on) also tend to attack the zeolite framework by causing complete de-alumination of the framework aluminum. For example, it is believed that a major portion of the aluminum in a low SAR zeolite (e.g., with SAR below 30) may completely de-aluminate at the low pH associated with existing phosphorus incorporation processes (e.g., phosphoric acid spray drying process and the like). Furthermore, it is believed that existing phosphorus incorporation processes may only rarely result in the phosphorus bonding properly with the framework aluminum, so that the phosphorus that is introduced in fact goes to the “wrong” place in or on the zeolite. Without being bound by theory, it is believed that part of the reason for this may be that the existing methods commonly evaporate the water from the phosphoric acid thereby concentrating it. This in turn results in polymerization of phosphoric acid to phosphate chains instead of binding to individual framework Al sites, thus leaving a corresponding number of framework Al sites unprotected.

These existing approaches lack a method to controllably effect the condensation, or its equivalent, of H₃PO₄ onto framework aluminum in low SAR zeolites such that (1) the framework is ultimately intact and stable towards harsh conditions of steam, temperature, and acid, (2) polyphosphates are not formed, and (3) high levels of phosphorus and framework aluminum are present in order to provide high activity in the form of P-treated zeolite powders and composite materials subsequently made from them.

An alternative process of forming phosphated zeolite using a phosphorus stabilization reaction on a zeolite comprising Alta is described in detail in International Application No. PCT/US2021/054218, filed on Oct. 8, 2021, the disclosure of which is hereby incorporated by reference herein in its entirety. In this process, phosphorus stabilization of template-free beta was achieved by a novel condensation process which gave improvements over simple impregnation or ‘drop in’ replacement of high SAR templated beta zeolite with non-templated beta zeolite. It has been identified that the process of framework bond breaking and complete de-alumination, also referred to as Si—O—Al bond hydrolysis, is kinetically fast at low pH, e.g., at a pH of about 2 (even at room temperature). Hence, the Si—O—Al bond hydrolysis is fast with existing methods phosphorus modification (incipient wetness, impregnation, slurrying phosphoric acid with zeolite, phosphoric acid spray drying, and so on), which contributes to the phosphorus being introduced to the “wrong” place in or on the zeolite. In comparison to Si—O—Al bond hydrolysis, condensation is a kinetically slow process. It was previously identified that adding a phosphorus source (e.g., phosphoric acid) slowly (e.g., by titration) to a zeolite with partially dislodged tetrahedral framework aluminum (Al_{Td}) at a controlled temperature and at a controlled pH allows a condensation reaction to occur between the phosphorus source and the AlTa in a deliberate and controlled manner so that the phosphorus is introduce into the “right” place on the zeolite.

In contrast to the above-described methods, the current embodiments utilize highly acidic conditions to promote bulk extraction of aluminum into the solution phase followed by neutralization to raise the reaction pH to a level that promotes healing of the framework (by re-condensation of extracted aluminum and repair hydrolyzed Al—O—Si) and condensation of phosphorus onto the framework in the form of Al—O-P. Advantages of the current embodiments include, but are not limited to 50% higher butylenes activity compared to standard templated beta zeolite components owing in part to an increased number of active aluminum sites, and increased overall P/Al of greater than about 0.5 in certain embodiments, because of the desirable stabilizing effect of phosphorus according to the present embodiments.

While the Examples reported here were formed using room temperature make-down of the butylenes maximization component ingredients, it is envisioned to combine the ingredients at an elevated temperature that would enable H₃PO₄ condensation onto the already phosphated zeolites of the inventive examples. Such an elevated temperature secondary condensation may move the zeolite P/Al from about 0.25 to about 0.5, or 0.5 to about 0.75 or 0.25 to about 1.0, and the like. The augmented zeolite could secondly be combined with the boehmite, clay and remaining H₃PO₄ to be spray dried into the component. Alternatively, it is envisioned that any of the additional ingredients in the component could also be present during the condensation-enabling make-down for spray drying the component.

Certain embodiments of the processes described herein are characterized as restoring the zeolite framework to have nearly all of its original aluminum substantially intact. This characterization derives from the novel process step of neutralizing the acidic extraction slurry with a base in the presence of phosphorus, such that some or all of the extracted aluminum are returned to the vacant tetrahedral framework sites, now as Al—O-P. When the extraction slurry reaches a pH of about 5, aluminum is essentially insoluble, so the once-extracted aluminum must either be re-inserted into the framework or precipitated as a separate aluminum hydroxide phase such as gelatinous boehmite AlOOH. In the presence of phosphate, that same extracted aluminum would likely form a gelatinous AlPO₄ hydrate, should an extracted zeolite not also be present. Without wishing to be bound be theory, it is believed that the re-insertion of the Al—O-P into the extracted framework in the presence of an extracted zeolite can be observed.

Certain embodiments utilize one or more acid treatments, with at least one of the acid treatments comprising a phosphorus source, such as H₃PO₄. Additional acids may be used in combination with H₃PO₄, which may be any acid with a pKa lower than H₃PO₄. In certain embodiments, these additional acids may include H₂SO₄, HNO₃, HCl, or a combination thereof. In certain embodiments, the healing step is performed with a base without use of additional acids in the acid treatment step(s). The healing step is thought to be useful whenever the pH of condensation is below about 2.35 (e.g., for TF beta zeolite) and there is some bulk dealumination. This can occur when high doses of H₃PO₄ alone are used.

In certain embodiments, the neutralization step utilizes a basic reagent to neutralize the acid(s) and promote the insertion/re-insertion of Al—O-P into the zeolite framework. Exemplary reagents include NH₄OH, NaOH, KOH, or their equivalents, or any base capable of raising the reaction pH from below 2 to about 5. In certain embodiments, the base is added in a titration mode, although another method might be used because the amount of base needed can vary. When a reasonable estimate of how much base may be needed, half of that amount may be added initially, with the remaining amount is added to reach the pH target reasonably quickly. If the amount of base needed were to be precisely known, it is contemplated that that amount of base may be added all at once.

In certain embodiments, the final reaction pH after neutralization can be about 5, but a range of about 3 to about 6 may also be effective (e.g., for template free beta zeolite). Other ranges may be useful depending on the zeolite used, as would be appreciated by those of ordinary skill in the art. It is believed that if the reaction pH is not raised enough, the aluminum (or a substantial portion thereof) will not be re-inserted, and if the pH is greater than about 6, phosphate begins to wash out of the phosphated zeolite. Moreover, when strong bases are added, it is important to avoid locally high pH values at the point of addition of the basic solution. Increasing the dilution of the base or the zeolite slurry, or increasing the extent of mixing, or injecting the basic solution into a location of high shear are each helpful in avoiding the undesired consequences of excessively high local pH. In certain embodiments, the healing step is performed, for example, at a temperature range of 60° C. to 80° C. (e.g., 70° C.) for 15 minutes to 60 minutes (e.g., 30 minutes) or more.

After the healing, if the starting zeolite was not already fully exchanged or converted to the proton form, or if NaOH or other alkali were used for neutralization, then the alkali-laden phosphated zeolite may be exchanged, surprisingly, without loss of the phosphate. It is known that non-bound phosphates are easily washed out of zeolites, and phosphate losses would be expected to increase in the concentrated ammonium nitrate or sulfate solutions used for ion exchange. However, it was found that in the pH range of about 3 to 5, 80%, 90%, or more of the phosphorus bound according to the present embodiments is retained during repeated ion exchange.

In certain embodiments, the phosphated zeolite is preferably calcined after the healing step and any desired ion exchange. After calcination, for example, at 500° C., a 38 ppm ²⁷Al NMR peak is observable when the NMR spectrum is measured under dry conditions. In certain embodiments, the zeolite is not heated excessively during calcination due to potential loss of crystallinity and high operating cost. In such embodiments, calcinations are performed at milder temperatures (e.g., less than 730° C.), lower steam concentrations (e.g. less than 100% steam, such as less than 40% or about 20%), and shorter residence times (e.g., less than 4 hours), which are typically associated with a rotary calciner or its equivalent. In certain embodiments, the 38 ppm feature in ²⁷Al NMR measured under dry conditions may have improved prominence after fluid bed calcination at, for example, 630° C. and 20% steam for 30 minutes, which condition has been found to give properties and performance equivalent to a large rotary calciner, or in air at 500° C. to 550° C. for no more than 2 hours.

In certain embodiments, the present disclosure provides a zeolite including a phosphated low SAR zeolite in which the P/Al molar ratio ranges from about 0.2 to about 0.9. The term “low SAR zeolite,” as used herein, refers to a zeolite with a SAR lower than about 30, lower than about 28, lower than about 25, lower than about 20, or lower than about 15. In certain embodiments the methods and compositions described herein encompass zeolites having a SAR of 30 or greater, e.g., a SAR ranging from about 5 to about 150, about 10 to about 100, or about 15 to about 50, or any sub-range or single SAR value therein. In at least one embodiment, the zeolite is a templated beta zeolite, having, for example, an SAR from 20 to 40. In at least one embodiment, the zeolite may comprise any structure having pore diameters large enough to allow dissolved P and Al species to freely diffuse in and out of the structure.

A variety of zeolites may be stabilized or phosphated in accordance with the process described herein. Exemplary zeolites that can be suitably stabilized or phosphated, according to embodiments described herein, may be selected, without limitations, from zeolites with the structure BEA (e.g., beta zeolite), MSE, -SVR, FAU (e.g., zeolite Y), MOR, CON, SOF, MFI (e.g., ZSM-5), IMF, FER, MWW, MTT, TON, EUO, MRE, NAT, CHA, TUN, YFI, or a combination thereof. In certain embodiments, the zeolites may be template-free, which, as used herein, refers to the zeolite having been formed without the use of an organic structure directing agent. In one embodiment, the zeolite is a template free zeolite having the structure BEA, for example template free beta zeolite. In one embodiment, the zeolite has a structure FAU, for example Y zeolite. In one embodiment, the zeolite has a structure MFI, for example ZSM-5.

In certain embodiments, zeolites that may be stabilized or phosphated as described herein include, without limitations, (1) large pore zeolites (e.g., those having pore openings greater than about 7 Angstroms) such as, for example, USY, REY, silicoaluminophosphates SAPO-5, SAPO-37, SAPO-40, MCM-9, metalloaluminophosphate MAPO-36, aluminophosphate VPI-5, or mesoporous crystalline material MCM-41; REUSY, zeolite X, zeolite Y, de-aluminated zeolite Y, silica-enriched de-aluminated zeolite Y, zeolite Beta, ZSM-3, ZSM-4, ZSM-18 and ZSM-20, (2) medium pore zeolites (e.g., those having pore openings of from about 4 Angstroms to about 7 Angstroms) such as, for example, ZSM-5, MCM-68, ZSM-11, ZSM-11 intermediates, ZSM-12, ZSM-22, ZSM-23, ZSM-35, ZSM-38, ZSM-48, ZSM-57 silicoaluminophosphate SAPO-31 and (3) small pore zeolites (e.g., those having pore openings of less than about 4 Angstroms) such as, for example, erionite and ZSM-34.

In certain embodiments, zeolites that may be stabilized or phosphated as described herein include, without limitations, zeolite A, zeolite B, zeolite F, zeolite H, zeolite K-G, zeolite L, zeolite M, zeolite Q, zeolite R, zeolite T, mordenite, erionite, offretite, ferrierite, chabazite, clinoptilolite, gmelinite, phillipsite and faujasite.

In certain embodiments, the zeolites described herein have an Al₂O₃ concentration of greater than about 4%, greater than about 8 wt %, greater than about 10 wt %, greater than about 12 wt %, greater than about 15 wt %, greater than about 20 wt %, or greater than about 25 wt %, based on total weight of the zeolite. In one embodiment, the zeolite is a template free beta zeolite with an Al₂O₃ concentration of greater than about 8 wt %, greater than about 10 wt %, greater than about 12 wt %, or greater than about 15 wt %, based on total weight of the zeolite. In certain embodiments, the Al₂O₃ concentration in the zeolites described herein is lower than 50 wt %, lower than 45 wt %, lower than 40 wt %, lower than 35 wt %, or lower than 30 wt %, based on total weight of the zeolite. The Al₂O₃ concentrations described herein may apply to a variety of zeolites that may be stabilized or phosphated according to embodiments described herein.

In certain embodiments, the zeolites described herein have a P₂O₅ concentration of greater than about 4 wt %, greater than about 5 wt %, greater than about 6 wt %, greater than about 7 wt %, greater than about 8 wt %, or greater than about 9 wt %, greater than about 10 wt %, greater than about 11 wt %, greater than about 12 wt %, greater than about 13 wt %, greater than about 14 wt %, or greater than about 15 wt %, based on total weight of the zeolite. In one embodiment, the zeolite is a template free beta zeolite with a P₂O₅ concentration of greater than about 4 wt %, greater than about 5 wt %, greater than about 6 wt %, greater than about 7 wt %, greater than about 8 wt %, or greater than about 9 wt %, greater than about 10 wt %, greater than about 11 wt %, greater than about 12 wt %, greater than about 13 wt %, greater than about 14 wt %, or greater than about 15 wt %, based on total weight of the zeolite. In certain embodiments, the P₂O₅ concentration in the zeolites described herein is lower than 30 wt %, lower than 25 wt %, lower than 20 wt %, lower than 19 wt %, lower than 18 wt %, lower than 17 wt %, lower than 16 wt %, or lower than 15 wt %, based on total weight of the zeolite. The P₂O₅ concentrations described herein may apply to a variety of zeolites that may be phosphate stabilized according to embodiments described herein.

In certain embodiments, the zeolites described herein have a P/Al molar ratio of the phosphated low SAR zeolite of greater than about 0.2, greater than about 0.3, greater than about 0.5, or greater than about 0.7. In one embodiment, the zeolite is a template free beta zeolite with a P/Al ratio of the template free beta zeolite of greater than about 0.2, greater than about 0.3, greater than about 0.5, or greater than about 0.7. For example, the P/Al molar ratio of the low SAR zeolites (e.g., template free beta zeolite) may range from about 0.2 to about 1, from about 0.5 to about 0.9, or from about 0.6 to about 0.8, or any sub-range or single P/Al molar ratio therein. In certain embodiments, similar P/Al molar ratios may be applicable for zeolites having a SAR of 30 or greater (high SAR zeolites). The P/Al molar ratios described herein may apply to a variety of zeolites that may be phosphate stabilized according to embodiments described herein.

Zeolites obtained by the process described herein are believed to be stabilized such that a catalyst component incorporating the zeolite maintains at least about 70%, at least about 80%, or at least about 90% of its crystallinity after steaming, with the maximum being 100%. In certain embodiments, the percent crystallinity that is maintained may be assessed by comparing the zeolite surface area after steaming (SZSA) to the zeolite surface area before steaming (ZSA). For instance, in certain embodiments, the SZSA of the components containing the zeolites obtained by the process described herein is at least about 70%, at least about 80%, at least about 85%, at least about 90%, or at least about 95% of its ZSA (with the maximum being 100%).

It is standard practice to employ XRD to assess the crystallinity of zeolites, but the results are semi-quantitative. ZSA is the zeolite micropore surface area, which is an alternative representation of the micropore volume quantitatively measured using nitrogen adsorption. The term “P-free ZSA” represents an attempt to be more quantitative about the crystallinity of the phosphated zeolite. For example, If one attempts to load P/Al=1.0 on a zeolite having a SAR of 10, the product would contain 16.8 wt % P₂O₅. Thus the original zeolite is already diluted down by 16.8%, so that if the P₂O₅ and zeolite were separate phases, one should already expect a significant 16.8 wt % ‘loss in ZSA’. But since the ‘loss’ is only by dilution, such a result is not to be taken as a true loss indicating destruction of the framework. On the other hand, if the H₃PO₄ were to be located solely inside the micropores of the zeolite, then in addition to the dilution effect, there should be a micropore volume loss due to pore volume occupation by the bound phosphate. Since the precise structure is not known, the effect is estimated from the molar volume of H₃PO₄. This leads to a semiempirical estimate that suggests, if successful at grafting inside zeolite, a ZSA loss of about 180 m²/g*P/Al is expected. As an example, a well-formed material with P/Al=0.5 can be thought of as having 90 m²/g higher micropore surface area than what is measured by N₂ adsorption. Given that the results are somewhat speculative, such estimates are denoted herein as “P-free ZSA.”

The zeolites described herein have many applications, including, without limitations, as part of a catalyst component (e.g., for fluid catalytic cracking), as part of an adsorbent, or as part of an ion exchange material, to name a few.

In one embodiment, the instant disclosure encompasses a catalyst component that includes any of the zeolites described herein with a non-zeolitic matrix. The instant disclosure also contemplates a process for preparing a catalyst component by combining any of the zeolites described herein with a non-zeolitic matrix.

The non-zeolitic matrix in a catalyst component that includes any of the zeolites described herein may include, without limitations, clay, rare earth-doped alumina (e.g., selected from one or more of ytterbium-doped alumina, gadolinium-doped alumina, cerium-doped alumina, or lanthanum-doped alumina), SiO₂-Al₂O₃ matrix, silica-doped alumina, gamma-alumina, χ-alumina, δ-alumina, θ-alumina, κ-alumina, boehmite, mullite, spinel, kaolinite, halloysite, montmorillonite, bentonite, attapulgite, kaolin, amorphous kaolin, metakaolin, hydrous kaolin, gibbsite (alumina trihydrate), titania, alumina, silica, silica-alumina, silica-magnesia, magnesia, sepiolite, or mixtures of two or more thereof.

Any of the zeolites described herein may be included in a catalyst component at an amount of at least 0.1 wt %, at least about 0.3 wt %, at least about 0.5 wt %, at least about 0.7 wt %, at least about 1 wt %, at least about 1.5 wt %, at least about 2 wt %, at least about 2.5 wt %, at least about 3 wt %, at least about 3.5 wt %, at least about 4 wt %, at least about 4.5 wt %, at least about 5 wt %, at least about 6 wt %, at least about 7 wt %, at least about 8 wt %, at least about 9 wt %, at least about 10 wt %, at least about 15 wt %, at least about 20 wt %, at least about 30 wt %, at least about 35 wt %, at least about 40 wt %, at least about 45 wt %, at least about 50 wt %, at least about 55 wt %, at least about 60 wt %, at least about 65 wt %, at least about 70 wt %, at least about 75 wt %, or at least about 80 wt %, based on total weight of the catalyst component.

In certain embodiments, any of the zeolites described herein may be included in a catalyst component in an amount of up to about 40 wt %, up to about 35 wt %, up to about 30 wt %, up to about 25 wt %, up to about 20 wt %, up to about 15 wt %, up to about 10 wt %, up to about 9 wt %, up to about 8 wt %, up to about 7 wt %, up to about 6 wt %, up to about 5 wt %, up to about 4.5 wt %, up to about 4 wt %, up to about 3.5 wt %, up to about 3 wt %, up to about 2.5 wt %, up to about 2 wt %, up to about 1.5 wt %, up to about 1 wt %, up to about 0.8 wt %, up to about 0.5 wt %, up to about 0.3 wt %, based on total weight of the catalyst component.

In certain embodiments, any of the phosphate stabilized zeolites described herein may be combined in a single catalyst component with one or more additional zeolites (e.g., a phosphate stabilized beta and/or a phosphate stabilized ZSM-5 may be combined with a Y zeolite). Existing catalyst components (e.g., incorporated catalyst components) tend to minimize or omit phosphorus because it is believed that the phosphorus could migrate within the catalyst component and poison (or adversely affect) constituents within the catalyst component (e.g., other zeolitic constituents or non-zeolitic matrix constituents). Without being construed as limiting, it is believed that the phosphate stabilized zeolites, as described herein, bind the phosphorus in such a deliberate and controlled manner that the phosphorus will remain bound to the zeolite rather than detach and/or migrate to other constituents within the catalyst component. Hence, it is believed, that the phosphate stabilized zeolites described herein may be combined in a single catalyst component with other constituents, that would otherwise be sensitive to phosphorus, without poisoning or adversely affecting such constituents.

The one or more additional zeolites (that can be combined in a single catalyst component with the phosphate stabilized zeolites described herein) may be selected from zeolites with the structure BEA (e.g., beta zeolite), MSE, -SVR, FAU (e.g., zeolite Y), MOR, CON, SOF, MFI (e.g., ZSM-5), IMF, FER, MWW, MTT, TON, EUO, MRE, NAT, CHA, TUN, YFI, or a combination thereof. In certain embodiments, the one or more additional zeolites (that can be combined in a single catalyst component with the phosphate stabilized zeolites described herein) include, without limitations, (1) large pore zeolites (e.g., those having pore openings greater than about 7 Angstroms) such as, for example, USY, REY, silicoaluminophosphates SAPO-5, SAPO-37, SAPO-40, MCM-9, metalloaluminophosphate MAPO-36, aluminophosphate VPI-5, or mesoporous crystalline material MCM-41; REUSY, zeolite X, zeolite Y, de-aluminated zeolite Y, silica-enriched de-aluminated zeolite Y, zeolite Beta, ZSM-3, ZSM-4, ZSM-18 and ZSM-20, (2) medium pore zeolites (e.g., those having pore openings of from about 4 Angstroms to about 7 Angstroms) such as, for example, ZSM-5, MCM-68, ZSM-11, ZSM-11 intermediates, ZSM-12, ZSM-22, ZSM-23, ZSM-35, ZSM-38, ZSM-48, ZSM-57 silicoaluminophosphate SAPO-31 and (3) small pore zeolites (e.g., those having pore openings of less than about 4 Angstroms) such as, for example, erionite and ZSM-34. In certain embodiments, the one or more additional zeolites (that can be combined in a single catalyst component with the phosphate stabilized zeolites described herein) include, without limitations, zeolite A, zeolite B, zeolite F, zeolite H, zeolite K-G, zeolite L, zeolite M, zeolite Q, zeolite R, zeolite T, mordenite, erionite, offretite, ferrierite, chabazite, clinoptilolite, gmelinite, phillipsite and faujasite.

In certain embodiments, a catalyst component that includes any of the zeolites described herein may be a first catalyst component in a catalyst composition that includes at least a second catalyst component (and optionally additional catalyst component(s)). The first catalyst component and the second catalyst component (and any additional catalyst component(s), if included) may be mixed, blended, or combined together to form the final catalyst composition. The final catalyst composition may be used for fluid catalytic cracking (FCC). In certain embodiments, the catalyst component may be, or be included as part of an FCC additive composition.

The second catalyst component may be compositionally different from the first catalyst component. Similarly, any additional catalyst component(s), if included, may be compositionally different from the first catalyst component and from the second catalyst component.

In certain embodiments, the second catalyst component and/or any additional catalyst component(s) may include zeolites with the structure BEA (e.g., beta zeolite), MSE, -SVR, FAU (e.g., zeolite Y), MOR, CON, SOF, MFI (e.g., ZSM-5), IMF, FER, MWW, MTT, TON, EUO, MRE, NAT, CHA, TUN, YFI, or a combination thereof.

In certain embodiments, the second catalyst component and/or any additional catalyst component(s) may include (1) large pore zeolites (e.g., those having pore openings greater than about 7 Angstroms) such as, for example, USY, REY, silicoaluminophosphates SAPO-5, SAPO-37, SAPO-40, MCM-9, metalloaluminophosphate MAPO-36, aluminophosphate VPI-5, or mesoporous crystalline material MCM-41; REUSY, zeolite X, zeolite Y, de-aluminated zeolite Y, silica-enriched de-aluminated zeolite Y, zeolite Beta, ZSM-3, ZSM-4, ZSM-18 and ZSM-20, (2) medium pore zeolites (e.g., those having pore openings of from about 4 Angstroms to about 7 Angstroms) such as, for example, ZSM-5, MCM-68, ZSM-11, ZSM-11 intermediates, ZSM-12, ZSM-22, ZSM-23, ZSM-35, ZSM-38, ZSM-48, ZSM-57 silicoaluminophosphate SAPO-31 and (3) small pore zeolites (e.g., those having pore openings of less than about 4 Angstroms) such as, for example, erionite and ZSM-34.

In certain embodiments, the second catalyst component and/or any additional catalyst component(s) may include zeolite A, zeolite B, zeolite F, zeolite H, zeolite K-G, zeolite L, zeolite M, zeolite Q, zeolite R, zeolite T, mordenite, erionite, offretite, ferrierite, chabazite, clinoptilolite, gmelinite, phillipsite and faujasite.

Hydrothermally and/or chemically modified versions of many of the components described herein may also be suitable as the at least one additional component in the FCC catalyst compositions contemplated herein.

The instant disclosure also encompasses methods of using the catalyst component by itself, as part of an FCC catalyst composition, or as part of an FCC additive composition, to crack a hydrocarbon feed. The methods include contacting said hydrocarbon feed with any of the catalyst components described herein or with any of the FCC catalyst compositions described herein or with any of the FCC additive compositions described herein.

In one embodiment, the instant disclosure encompasses an adsorbent that includes any of the zeolites described herein and a substrate. In one embodiment, the instant disclosure encompasses an ion exchange material that includes any of the zeolites described herein. Any of the zeolites described herein may be combined with a suitable substrate or any other suitable constituent, as understood by those skilled in the art, in order to form an adsorbent or an ion exchange material.

### ILLUSTRATIVE EXAMPLES

The following examples are set forth to assist in understanding the disclosure and should not be construed as specifically limiting the invention described and claimed herein. Such variations of the invention, including the substitution of all equivalents now known or later developed, which would be within the purview of those skilled in the art, and changes in formulation or minor changes in experimental design, are to be considered to fall within the scope of the invention incorporated herein.

### Examples 1-6

In these examples, the 9.6 SAR TF-beta zeolite was phosphated by extraction/condensation at about 1.75 pH, healed at pH 5, exchanged if needed to reduce Na₂O, and then split and either calcined in static air at 500° C. for 2 hours or fluid bed calcined (FBC) at 1167° F. and 20% steam for 30 minutes. The latter method is a realistic mimic of a rotary calciner. The former air-calcined samples were subsequently steamed at 1500° F. in 100% steam for 4 hours in a simple accelerated aging test meant to emulate beta zeolite component deactivation in an FCC unit.

As shown in Table 1, Examples 1 and 2 began with Na-beta zeolite and 3 and 4 began with H-beta zeolite. A 0.70H₂SO₄/Al dose was first added all at once using 28 wt % H₂SO₄ to the 20% solids beta slurry stirring at 70° C., and mixing was performed for 30 minutes. 28% H₃PO₄ was then similarly added all at once at a dose of 0.75 or 0.5 and this was mixed for another 30 minutes. Aliquots of the slurry were taken after acid addition and these were filtered, washed, dried and submitted for analysis. After the mixing period was completed, the acidified slurries were neutralized with NH₄OH or NaOH solutions, and then in the case of Example 4, a second healing base of NH₄OH was added, according to the dosages listed in Table 1. The healing slurries were again mixed for 30 minutes at 70° C., then filtered and washed, and the filter cakes were dried. As can be seen in Table 1, half or more of the framework Al was extracted into solution during the acidification steps and very little P₂O₅ was found on the extracted solids. After neutralization, however, the SAR of the solids returned to near the initial value but now with about 10 wt % of P₂O₅ (4.4 wt % elemental P, P/Al˜ 0.58) and amounts of Na₂O consistent with the starting material and the reagents of neutralization. Examples 1-3 were therefore exchanged to reduce Na₂O<0.3 wt % wherein a small proportion of the healing stage P was lost, but XRD indicated that zeolite beta was the only crystalline phase; some amorphous material was also present. After calcination in air, the ZSA confirmed zeolite was present and the P-free ZSA estimate suggested that the observed reduction in ZSA versus the parent material was well accounted for by the dilution with P₂O₅ and micropore volume occupation by H₃PO₄.

TABLE 1
Parameters and results for extraction, healing, and calcination

| | | Example: | | | | |
|---|---|---|---|---|---|---|
| | | 1 | 2 | 3 | 4 | 6 |
| | | Zeolite: | | | | |
| Process | | Na-TF- | Na-TF- | H-TF- | H-TF- | NH₄-TF- |
| Step: | | BEA | BEA | BEA | BEA | BEA |
| Extraction | H₂SO₄/Al, m/m | 0.69 | 0.70 | 0.7 | 0.7 | |
| | P/Al dose, m/m | 0.75 | 0.75 | 0.515 | 0.495 | |
| | SiO₂, wt % | 86.7 | 86.4 | 92.4 | 88.5 | |
| | Al₂O₃ | 8.3 | 7.9 | 3.9 | 5.9 | |
| | Na₂O | 2.7 | 2.8 | 0.01 | 0.02 | |
| | P₂O₅ | 0.76 | 0.79 | 0.25 | 0.88 | |
| | SAR, m/m | 17.8 | 18.6 | 40.5 | 25.4 | |
| | % Dealumination | 47% | 49% | 77% | 63% | |
| Healing | 1st Heal Base | NH₄OH | NaOH | NaOH | NaOH | — |
| | 2nd Heal base | — | — | — | NH₄OH | — |
| | 1st Base/Acid Dose | 0.93 | 0.81 | 1.21 | 0.092 | |
| | 2nd Base/Acid | 0 | 0 | 0 | 1.14 | |
| | Dose | | | | | |
| | Na₂O | 1.91 | 5.6 | 2.71 | 0.27 | |
| | P₂O₅ | 10.2 | 10.3 | 10.4 | 9.9 | |
| | SAR | 9.25 | 9.27 | 9.41 | 9.43 | |
| | P/Al | 0.58 | 0.59 | 0.59 | 0.55 | 0 |
| Exchanges | # of Exchanges | 2 | 4 | 3 | 0 | — |
| | Na₂O | 0.23 | 0.19 | 0.09 | 0.27 | |
| | P₂O₅ | 10.12 | 9.95 | 10.69 | 9.91 | — |
| | P/Al | 0.54 | 0.53 | 0.57 | 0.55 | |
| | XRD Major Phase | Beta | Beta | Beta | Beta | Beta |
| | XRD Minor Phase | — | — | — | — | |
| Calcination | ZSA | 342 | 347 | 329 | 342 | ~440 |
| | ZSA, P-free | 446 | 454 | 436 | 441 | |
| | XRD Major Phase | Beta | Beta | n m | Beta | n m |
| | XRD Minor Phase | Trace | Trace | | — | |
| | | AlPO₄ | AlPO₄ | | | |
| | ²⁷Al NMR (dry) | 38 ppm | 38 ppm | | 38 ppm | |
| | μmol NH₃ /g P-Beta | 1904 | 1834 | 2310 | 1486 | 2711 |
| | NH₃/(starting Al), | | | | | |
| | m/m | 72% | 69% | 88% | 58% | 92% |

Aluminum NMR was employed to further characterize and understand the materials. All NMR experiments were performed on an Agilent DD2 600 MHZ (14.1 T) spectrometer. Aluminum-27 NMR spectra were measured using a 3.2 mm spinning assembly at spinning rates of 15-20 kHz. One dimensional NMR spectra were obtained using non-selective p/12 pulses. Typically, 4-8 k scans were acquired with a relaxation delay of 1-2 s. 1.0 M Al(NO₃)₃ solution was used to calibrate the rf field and was used as a primary reference. Prior to measurements, samples that were run dry were recovered promptly from calcination and stored in desiccators with Drierite. NMR samples run hydrated were placed in a different desiccator box containing a saturated solution of NH₄NO₃ solution and equilibrated for at least 48 hours.

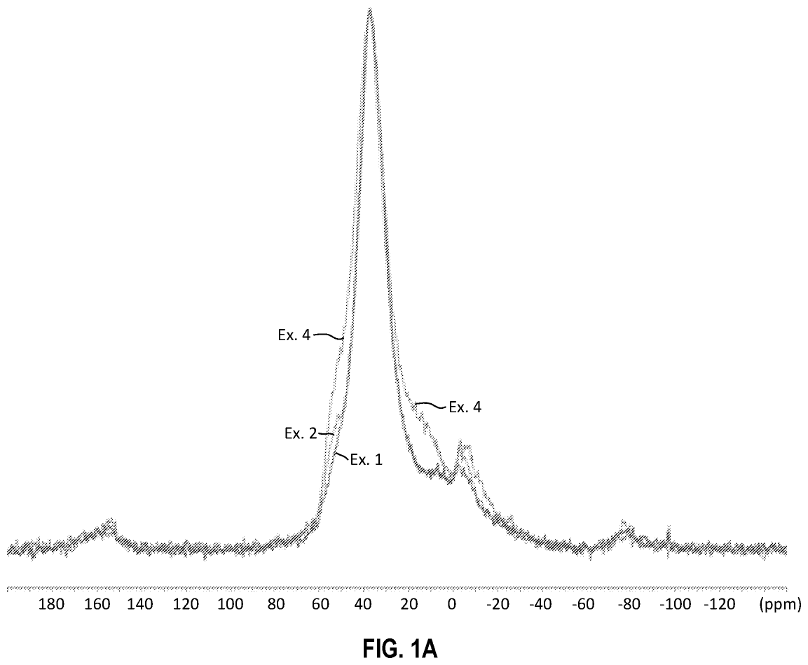

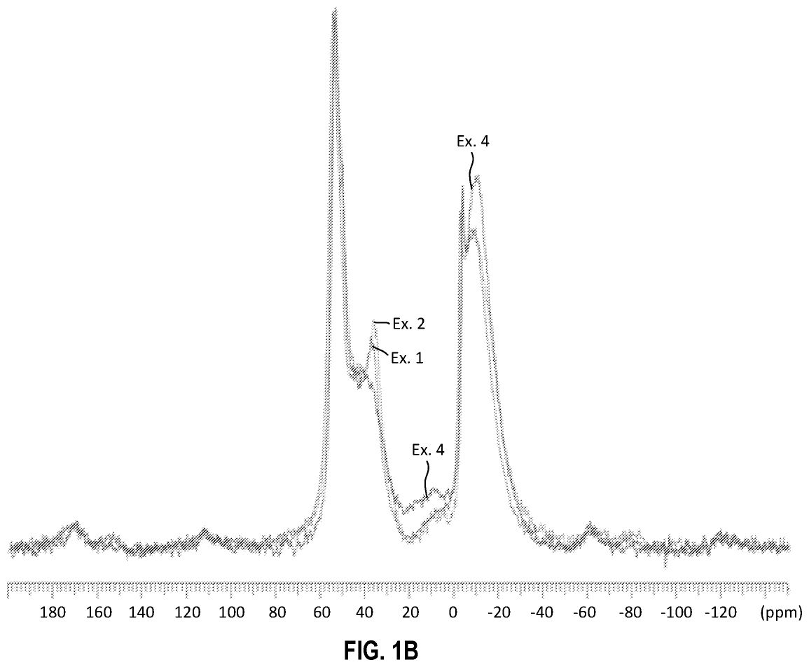

FIGS. 1A and 1B show ²⁷Al NMR spectra after calcination in air for Examples 1, 2 and 4 under dry (FIG. 1A) and hydrated (FIG. 1B) conditions. ²⁷Al NMR run dry on the calcined samples (FIG. 1A; #3 and #6 were not run) exhibited a clear majority of the spectral area centered on about 38 ppm, indicating that a tetrahedral Al—O-P had been formed without the need for steam deactivation or aging procedures. This result is believed to be partly due to Al_{T} resonance not being visible when run dry, but still indicative of Al—O-P being intrinsically tetrahedral. XRD on the calcined sample detected majority beta zeolite, but only a trace amount of dense AlPO₄, along with indications of an amorphous material, as is typical. The finding of 38 ppm after dry calcination is a significant result as steam-deactivation was not required, and which itself suggests dense phase AlPO₄ formation. Dense AlPO₄ would provide narrow NMR resonances, however, so the NMR spectra in FIG. 1 are not consistent with dense AlPO₄ being present, in agreement with XRD. Also consistent with that interpretation, NH₃ temperature-programmed desorption (TPD) revealed (Table 1) that the total acidity of the materials corresponded to 58-88% of the original framework Al, compared to 92% for calcined beta zeolite without P. Some loss is expected due to weakening of acid sites.

27 Al NMR spectra were also run on the samples after hydration (FIG. 1B), and these show the expected re-appearance of unmodified Al_{T} at about 55 ppm, which is consistent with having extracted Al return to the framework while having a P/Al of about 0.58. The 38 ppm Al-O-P appears to be reduced however (spectra normalized to maximum intensity, not quantitatively calibrated), and broad new octahedral Al resonances appear between about 0 to −20 ppm. Without wishing to be bound by theory, it is now believed that the desired Al—O-P mono- or bi-dentate structures cannot be four coordinated to the framework O—Si, which renders them somewhat or very susceptible octahedral coordination upon adsorption of water. Still, this does not preclude their being bound to the framework.

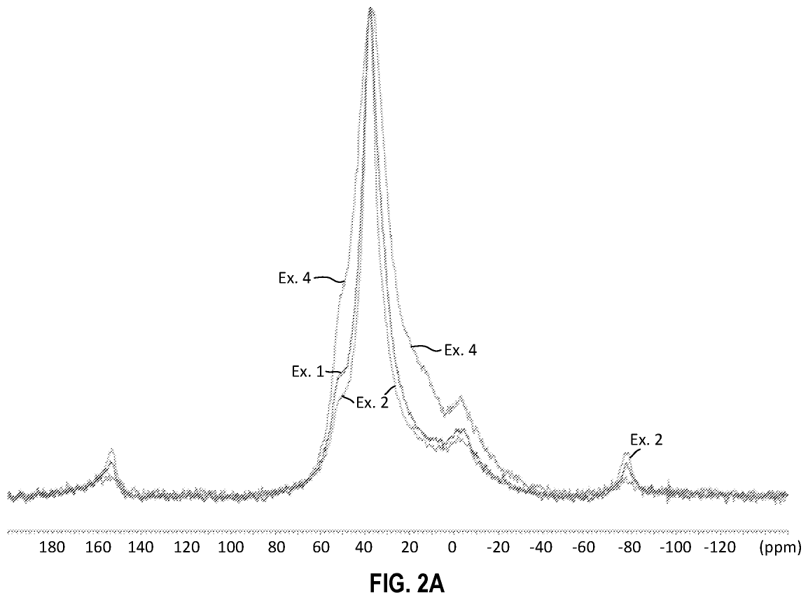

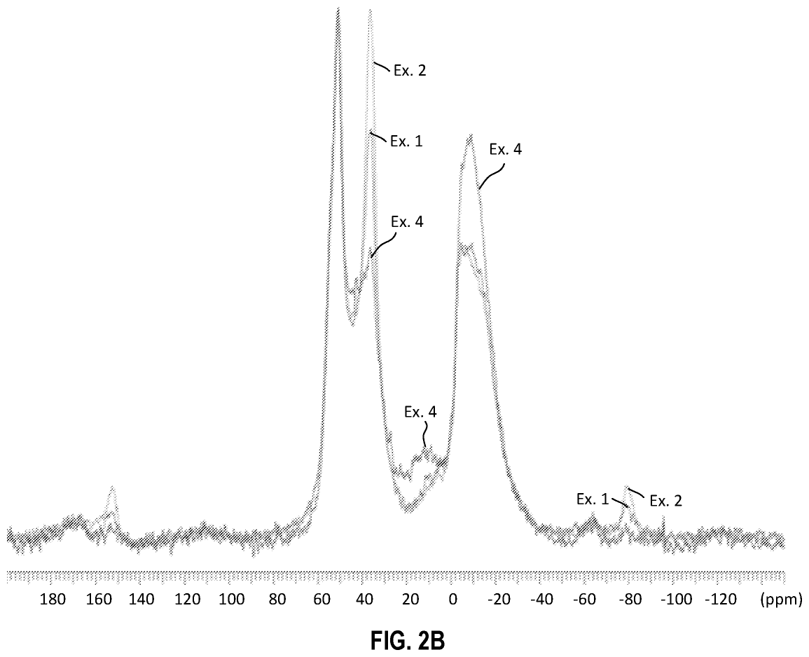

The results from the fluid bed calcination (FBC) of the dried samples and steam-deactivation of the calcined powder samples are shown in Table 2, and NMR results for FBC are shown in FIGS. 2A and 2B for dry and hydrated conditions, respectively. After FBC, ZSA indicates micropores are present, and XRD detects majority beta zeolite and NH₃ TPD acidity is equivalent to 49-59% of starting framework Al, as compared to 53% for unmodified beta zeolite, each suggesting the modified zeolite is structurally intact. ²⁷Al NMR (FIG. 2A) on sample 1 and 2 run dry shows 38 ppm Al—O-P, with perhaps some peak narrowing. A trace of dense AlPO₄ was found on 1 and 2 by XRD but this is not believed to be a significant contributor. When the material was hydrated for NMR, it then displayed both the 56 ppm and the 38 ppm signals at the same time. Without wishing to be bound by theory, it is believed that the FBC may have allowed for some re-condensation of hydrolyzed Al—O—Si, so that some/more pristine monodentate (—Si—O—)₃Al—O-P was formed. This would explain the spectra if monodentate, hypothetically 3-coordinated to the framework, is rigid enough to be hydrophobic and remains tetrahedral, while any original 1- or 2-coordinated monodentate, i.e. (—Si—O—)ₙAl—O-P where n=1 or 2, or 2-coordinated bidentate, were to have more freedom of movement and converts to octahedral coordination upon hydration for NMR. If true, the result implies that the structural integrity of the site would be improved during manufacture by rotary calcination.

After powder steaming at 1500° F., along with the majority beta phase, distinct AlPO₄ reflections were found for Examples 1 and 2 (Table 2).

TABLE 2
Results for phosphated TF beta zeolite powders after
fluid bed calcination or steam-deactivation.

| | | Example: | | | | |
|---|---|---|---|---|---|---|
| | | 1 | 2 | 3 | 4 | 6 |
| Powder FBC | PWDR FBZSA | 292 | 291 | 297 | 298 | 353 |
| | XRD Major Phase | Beta | Beta | n m | Beta | n m |
| | XRD Minor Phase | Trace | Trace | | — | |
| | | AlPO₄ | AlPO₄ | | | |
| | ²⁷Al NMR (dry) | 38 ppm | 38 ppm | | 38 ppm | |
| | μmol NH₃ /g P-Beta | 1484 | 1292 | 1316 | 1493 | 1571 |
| | NH₃/(starting Al), | 56% | 49% | 50% | 59% | 53% |
| | m/m | | | | | |
| Steaming | SZSA | 204 | 187 | 207 | 199 | 254 |
| | SZSA % retained | 60% | 54% | 63% | 58% | |
| | XRD Major Phase | Beta | Beta | Beta | Beta | Beta |
| | XRD Minor Phase | Clear | Clear | — | — | — |
| | | AlPO₄ | AlPO₄ | | | |
| | ²⁷Al NMR (dry) | Narrow | Narrow | not run | 38 ppm | not run |
| | | 38 ppm | 38 ppm | | | |
| | μmol NH₃ /g P-Beta | 296 | 334 | 338 | 360 | 265 |
| | NH₃/(starting Al), | 11% | 13% | 13% | 14% | 9% |
| | m/m | | | | | |
| | % increase due to P | 24% | 41% | 43% | 58% | 0% |
| | Site Density, μmol | 1.45 | 1.79 | 1.63 | 1.81 | 1.04 |
| | NH₃/m² | | | | | |
| | % increase due to P | 39% | 72% | 57% | 73% | 0% |

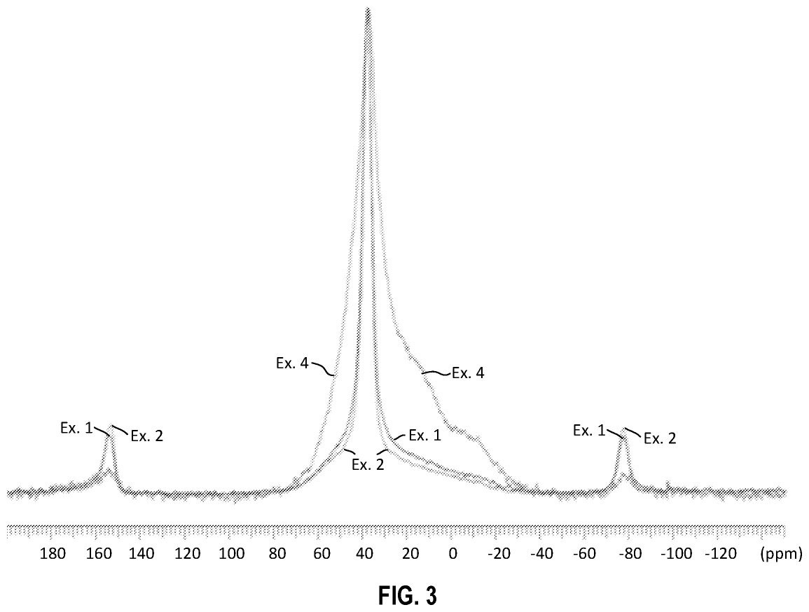

FIG. 3 shows spectra from ²⁷Al NMR run dry after powder steaming. The 38 ppm dry NMR resonances have also narrowed for those two samples, as would be directionally expected for dense AlPO₄. The SZSAs were about 20% lower than the P-free control, but 10% reduction is still accounted for by dilution with P₂O₅ and about 60% of the calcined ZSA remains. Further, the acidity was 24-58% higher for the phosphated TF beta zeolite and the steamed acid site density is 39-73% higher for the phosphated versus non-phosphated beta zeolite. These results are consistent with improving activity in butylenes production.

### Examples of Extraction/Healing Taken Through Spray Drying

The following extraction and healing examples were prepared with or without a second acid, and from Na- or H-form TF-BEA zeolite, and carried through to spray drying, calcination and steam-deactivation for a butylenes activity test. Extractions and healings were carried out at 70° C. with 30 minute soak times as before, with samples being taken after acid addition(s), after NH₄OH re-insertion/healing at pH=5, and after calcination at 500° C. in air for 2 hours. The results are summarized in Table 3.

As shown in Table 3, Example 8 began with Na-form zeolite that subsequently was exchanged, whereas the others began with H-form made by pre-calcining NH₄-TF-BEA at 500° C. in air for 2 hours. Examples 7 and 8 were controlled to pH targets of 2.1 and 1.8, requiring the noted acid dose(s). It has been found that driving to pH targets is less reproducible than using pre-determined acid doses. Accordingly, Examples 9-11 were dosed as shown in Table 3 with the expectation that the resulting pH would be close to 1.75. Examples 9 and 10, which combined samples and were subsequently split and employed a low 0.25 P/Al dose, were able to reach such a low pH due to the use of the second acid H₂SO₄. Examples 8-11 experienced more than 50% bulk dealumination during acidification, but healing at pH 5 brought the SAR back to within experimental error of the base material SAR.

TABLE 3
Preparation of raw materials for spray drying.

| | | Examples: | | | |
|---|---|---|---|---|---|
| | | 7 | 8 | 9 and 10 | 11 |
| | | Zeolite | | | |
| | | H-TF- | Na-TF- | H-TF- | H-TF- |
| | | Beta | Beta | Beta | Beta |
| Extraction | Cond. pH | 2.1 | 1.8 | [1.75] | [1.75] |
| | H₂SO₄/Al | 0 | 0.47 | 0.7 | 0.7 |
| | P/Al dose | 1.0 | 0.75 | 0.25 | 0.5 |
| | % | 10% | 67% | 54% | 57% |
| | Dealumination | | | | |
| | P/A1 | 0.62 | 0.11 | 0.03 | 0.09 |
| Healing | Na₂O (exch) | 0.05 | 3.36 (0.14) | 0.05 | 0.03 |
| | SAR | 9.43 | 9.5 | 9.37 | 9.25 |
| | P/Al (exch) | 0.78 | 0.56 (0.49) | 0.26 | 0.49 |
| Calcination | ZSA, Calcined | 334 | 260 | 340 | 314 |
| | ZSA, P-free | 474 | 348 | 387 | 403 |

The foregoing materials were media milled less than about 4 microns, then combined with high shear mixing in the order of zeolite at about 20% solids, peptized boehmite at 7.5% solids, clay at 70% solids, and 28 wt % phosphoric acid last, to form slurries of about 22% solids. The mixtures were spray dried with a single fluid nozzle dryer.

Table 4 shows that the component P/Al and zeolite loading targets varied somewhat, with Examples 9 and 10 having both lower preloaded P/Al and lower component P/Al targets. Example 11 targeted low zeolite loading, and because that would benefit attrition, the boehmite loading was reduced as well, with the final effect being to substantially lower the amount of H₃PO₄ used at spray drying. Thus, Examples 9-11 represented attempts to reduce any residual damage done to the TF-beta zeolite during spray drying with H₃PO₄, each featuring lower overall P₂O₅.

TABLE 4
Spray drying and performance testing of P-TF-beta zeolites from Table 3.

| | | Example: | | | | |
|---|---|---|---|---|---|---|
| | | 7 | 8 | 9 | 10 | 11 |
| Spray Dry | Component P/Al Target | 1.0 | 1.0 | 0.70 | 0.85 | 0.872 |
| | BEA Target, SiAl basis | 40 | 40 | 40 | 40 | 25 |
| | Boehmite target, VF | 6.5 | 6.5 | 6.5 | 6.5 | 4 |
| | Na₂O, wt % | 0.13 | 0.16 | 0.16 | 0.14 | 0.18 |
| | As determined via XRF: | | | | | |
| | % Clay, VF | 36.6 | 36.7 | 39.4 | 38.0 | 56.5 |
| | % boehmite, VF | 6.6 | 6.4 | 6.2 | 6.1 | 4.4 |
| | % P₂O₅, VF | 17.0 | 17.1 | 11.6 | 13.8 | 10.3 |
| | BEA loading, P-free | 39.9 | 40.0 | 42.9 | 42.2 | 28.9 |
| | Component P/Al, Actual | 0.98 | 1.00 | 0.66 | 0.79 | 0.85 |
| | Component ZSA | 103 | 111 | 128 | 126 | 86 |
| | ZSA/SiAlBeta*40 | 104 | 111 | 119 | 119 | 119 |
| Steaming | Component SZSA | 93 | 100 | 96 | 101 | 69 |
| | SZSA % retained | 90 | 90 | 75 | 80 | 80 |
| ACE | Activity/Control, % | 153 | 148 | 140 | 147 | 95 |
| | (Activity/SZSA) vs Control, % | 212 | 192 | 196 | 195 | 184 |

It was found by deconvolution of the x-ray fluorescence (XRF) results that the components were reasonably close to their intended compositions. The spray dried and calcined ZSAs were highest on the low P/Al Examples 9 and 10, although correction to 40% beta loading reduces the expected ZSA to 119 m²/g. And, as appears to be typical, the advantage was not carried through to steamed ZSA. Example 11 was sprayed with lower zeolite content with the aim of stability improvement, but its ZSA corrected to 40% beta loading also yielded 119 m²/g. As expected, Example 11 steamed ZSA (SZSA) was lower than the others examples. By comparison, a control component made with 40% templated beta zeolite (as SiO₂-Al₂O₃) can be expected to yield 140 m²/g or more fresh ZSA and about 130 m²/g SZSA when steamed in the same way. The control (referred to herein as a “proper control”) was not preloaded with any phosphorus, and was not subjected to H₂SO₄ acid treatment or any healing, but was spray dried with H₃PO₄-boehmite binder and clay.

The activity for butylenes production was assessed by replacing increasing amounts of an inert ingredient with the butylenes component in an otherwise high activity butylenes maximization FCC catalyst. This allows the Y zeolite/oil ratio to remain constant while the beta/oil or ZSM-5/oil ratios are allowed to increase. The butylenes activity can be taken as the initial slope of the parabolic curve drawn through the total butylenes yield versus wt % of butylenes component contained in the ACE Technology fixed fluid bed reactor. Because Examples 7-11 were prepared in two different episodes of spray drying and three episodes of ACE activity determinations, for simplicity, Table 4 lists the activity relative to their respective controls, where the control activities are defined as 100% in each case.

The results for Examples 7-10 in Table 4 show that the phosphated zeolites of the inventive examples have +40 to +53% higher activity than their controls when spray dried at the same zeolite content. In Example 11, about 29 wt % (P-free basis) of phosphated zeolite provided just 5% less activity than a control butylenes component using the same binder technology and containing 40% zeolite. Both results demonstrate that the phosphated zeolites of the inventive examples have improved activity per weight of the beta zeolite.

Another aspect of Examples 7-10 in Table 4 is that the butylenes activity is obtained at about 25% lower SZSA. Dividing the activity data by SZSA then showed, on a relative basis, that the components of the inventive examples exhibit roughly twice the activity per SZSA as a control component. This result for butylene components is better than expected from the acid site density results listed in Table 2 for the phosphated zeolite powders themselves.

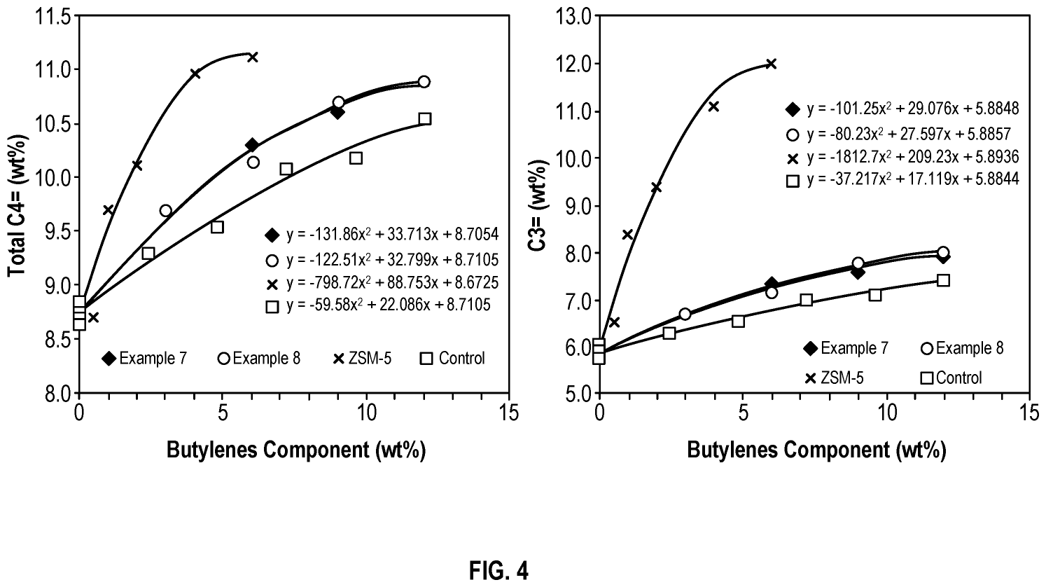

FIG. 4 shows the raw butylenes and propylene yields versus the amount of butylenes component in the ACE.

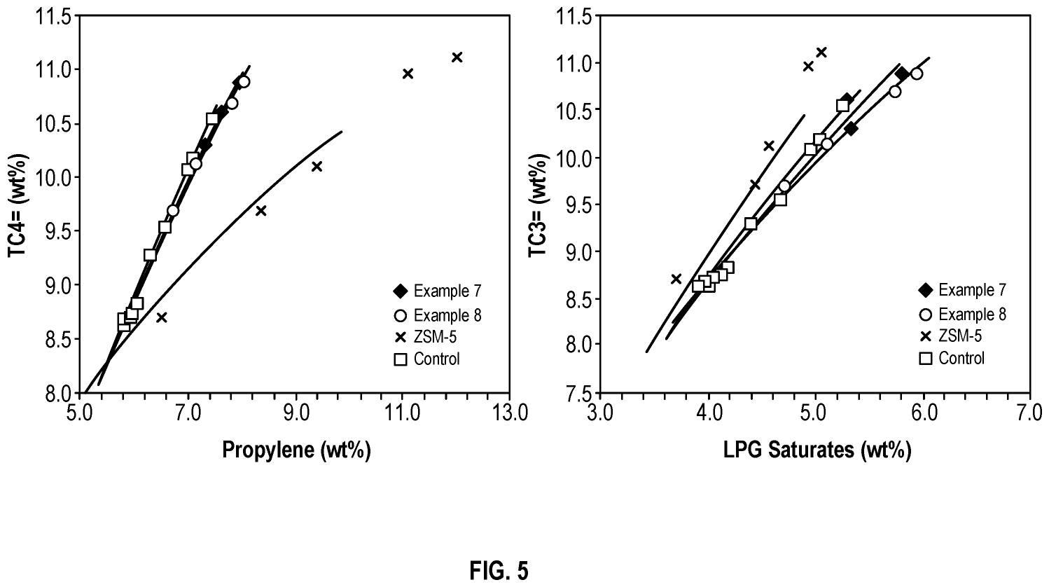

FIG. 5 shows that despite the activity improvement, the components of the inventive examples have no degradation in selectivity and that selectivity is essentially unchanged. Equivalent results were obtained in the other ACE campaigns.

### Methods

Standard ACE method: ACE (see U.S. Pat. No. 6,069,012) results over a range of conversions may be obtained by a constant time on stream protocol using vacuum gasoil at a cracking temperature of 1020° F. and an injector height of 2.125″, as described in U.S. Pat. No. 6,656,347 and later modified by Ind. Engr. Chem. (54) 5921.

Deactivation: All components were steam-deactivated at 1500° F. for four hours in 100% steam before measurement of the SZSA or evaluation in the ACE reactor.

Olefins components doping: Common olefins components such as ZSM-5 can be assessed by running cracks at constant base catalyst/oil ratio, but with increasing levels of first components doped in, and measuring the resulting incremental yields of butylenes and propylene. To keep bed height, contact time, fluidization and endotherms constant, additives replace an equivalent amount of clay microsphere diluent. The total grams of solids in the reactor is thus constant. The activity is the slope of the butylenes versus dose plot. The butylene versus propylene selectivity is the ratio of the two slopes. The relative activity of a butylenes maximization component is the ratio of the slope to that of a reference standard catalyst also prepared at pilot scale using the same loading of a high SAR templated beta zeolite and phosphated boehmite binder, where the standard component P/Al is about 1.06.

For simplicity of explanation, the embodiments of the methods of this disclosure are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events.

In the foregoing description, numerous specific details are set forth, such as specific materials, dimensions, processes parameters, etc., to provide a thorough understanding of the present invention. The particular features, structures, materials, or characteristics may be combined in any suitable manner in one or more embodiments. The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. Reference throughout this specification to “an embodiment,” “certain embodiments,” or “one embodiment” means that a particular feature, structure, or characteristic described in connection with the embodiment is included in at least one embodiment. Thus, the appearances of the phrase “an embodiment,” “certain embodiments,” or “one embodiment” in various places throughout this specification are not necessarily all referring to the same embodiment.

The present disclosure has been described with reference to specific exemplary embodiments thereof. The specification and drawings are, accordingly, to be regarded in an illustrative rather than a restrictive sense. Various modifications of the disclosure in addition to those shown and described herein will become apparent to those skilled in the art and are intended to fall within the scope of the appended claims.

1. A phosphated low silica to alumina ratio (SAR) zeolite, characterized by one or more of:
an ²⁷Al nuclear magnetic resonance (NMR) peak, when run under dry conditions, at about 38 ppm that represents at least 50% of the total spectral area;
a butylenes component steamed ZSA corrected to 40% Si—Al basis loading of 90 m²/g or greater;
a butylenes production activity of at least 1.4 times greater than the butylenes production activity of a proper control component made from a phosphorus-free high SAR templated zeolite having the same structure; or
an activity/SZSA of at least 1.8 times greater than an activity/SZSA of a proper control component made from a phosphorus-free high SAR templated zeolite having the same structure.

2. The zeolite of claim 1, wherein the P/Al molar ratio of the zeolite is greater than about 0.2.

3. The zeolite of claim 1, wherein the P/Al molar ratio of the zeolite is between about 0.2 and about 0.8.

4. The zeolite of claim 1, wherein the SAR of the zeolite is less than about 30.

5. (canceled)

6. The zeolite of claim 1, wherein the zeolite is selected from zeolites with the structure BEA, MSE, -SVR, FAU, MOR, CON, SOF, MFI, IMF, FER, MWW, MTT, TON, EUO, MRE, NAT, CHA, TUN, YFI, or a combination thereof.

7. The zeolite of claim 6, wherein the micropores of the zeolite structure comprise at least one of 10-member rings and/or 12-member rings.

8. The zeolite of claim 1, wherein the zeolite has BEA structure, optionally the zeolite is template free BEA having been produced without use of an organic template.

9. (canceled)

10. The zeolite of claim 8, having an Al₂O₃ concentration of greater than about 8 wt %, based on total weight of the zeolite.

11. The zeolite of claim 1, formed by
performing one or more acid treatments on a zeolite to at least partially extract framework aluminum from the zeolite, wherein at least one of the one or more acid treatments comprises a phosphorus source, and
subsequently increasing the reaction pH under conditions sufficient to induce re-insertion of at least a portion of the extracted framework aluminum onto the zeolite and condensation of phosphorus onto the zeolite.

12. The zeolite of claim 11, wherein the phosphorus source comprises phosphoric acid.

13. A catalyst component comprising the zeolite of claim 1 and a non-zeolitic matrix.

14. The catalyst component of claim 13, wherein the component maintains a ZSA of at least about 70%, at least about 80%, or at least about 90% after steaming.

15. (canceled)

16. (canceled)

17. A phosphated zeolite formed by performing one or more acid treatments on a zeolite to at least partially extract framework aluminum from the zeolite, wherein at least one of the one or more acid treatments comprises a phosphorus source, and
subsequently increasing the reaction pH under conditions sufficient to induce re-insertion of at least a portion of the extracted framework aluminum onto the zeolite and condensation of phosphorus onto the zeolite.

18. (canceled)

19. (canceled)

20. A process for forming phosphated zeolite, the process comprising:
performing one or more acid treatments on a zeolite, wherein at least one of the one or more acid treatments comprises a phosphorus source, wherein the one or more acid treatments cause at least partial extraction of framework aluminum from the zeolite; and
forming the phosphated zeolite by subsequently increasing the reaction pH under conditions sufficient to induce re-insertion of at least a portion of the extracted framework aluminum onto the zeolite and condensation of phosphorus onto the zeolite.

21. The process of claim 20, wherein at least a portion of the extracted framework aluminum is re-inserted as Al—O-P.

22. The process of claim 20, wherein the one or more acid treatments reduce the reaction pH to about 2.35 or less.

23. (canceled)

24. (canceled)

25. The process of claim 20, wherein increasing the reaction pH comprises increasing the reaction pH to about 5 or greater.

26. The process of claim 20, wherein the phosphorus source comprises phosphoric acid or one or more phosphates that result in the formation of phosphoric acid.

27. The process of claim 20, wherein the one or more acid treatments comprise treatment with a phosphorus-free acid prior to or simultaneously with treatment with the phosphorus source.

28. (canceled)

29. The process of claim 20, wherein the zeolite is selected from zeolites with the structure BEA, MSE, -SVR, FAU, MOR, CON, SOF, MFI, IMF, FER, MWW, MTT, TON, EUO, MRE, NAT, CHA, TUN, YFI, or a combination thereof.

30. The process of claim 20, wherein the zeolite has BEA structure, optionally the zeolite is template free BEA having been produced without use of an organic template.

32.-44. (canceled)

45. The process of claim 20, further comprising subsequently calcining the zeolite optionally at a temperature ranging from about 400° C. to about 650° C.

46. A process for forming a catalyst component, the process comprising
combining the zeolite of claim 1 and
a non-zeolitic matrix.

47. The process of claim 46, wherein the combining of the zeolite and the non-zeolitic matrix occurs in a slurry held at a temperature of at least 40° C. effective to induce the condensation of additional phosphate onto an already phosphated zeolite.

48. A fluid catalytic cracking (FCC) catalyst composition comprising:
a first component comprising the catalyst component of claim 13; and
at least one additional component that is compositionally different from the first component; and optionally
a non-zeolitic matrix.

49. The FCC catalyst composition of claim 48, wherein the second component comprises a zeolite selected from zeolites with the structure BEA, MSE, -SVR, FAU, MOR, CON, SOF, MFI, IMF, FER, MWW, MTT, TON, EUO, MRE, NAT, CHA, TUN, YFI, or a combination thereof.

50. The FCC catalyst composition of claim 48, wherein the second component comprises zeolite Y.

51. A method of cracking a hydrocarbon feed comprising contacting said feed with the FCC catalyst composition of claim 48.
